(19) United States
(12) Patent Application Publication
(10) Pub. No.: US 2008/0078628 A1
(43) Pub. Date: Apr. 3, 2008

(54) METHOD OF MODERNIZING AN ELEVATOR DOOR SYSTEM OF AN ELEVATOR INSTALLATION AND MODERNIZATION KIT FOR CARRYING OUT THE METHOD

(76) Inventor: Jules Christen, Altdorf (CH)

Correspondence Address: FRASER CLEMENS MARTIN & MILLER LLC, 28366 KENSINGTON LANE, PERRYSBURG, OH, 43551, US

(21) Appl. No.: 11/863,341

(22) Filed: Sep. 28, 2007

(30) Foreign Application Priority Data
Sep. 28, 2006 (EP) 06121442.5

(51) Int. Cl. B66B 1/00

(52) U.S. Cl. 187/319; 187/414

(57) ABSTRACT

A method of modernizing an elevator door system of an elevator installation wherein a door drive together with a car door/shaft door coupling, which is mounted at a car door in a door opening region thereof, and a shaft door lock, which is mounted at a shaft door in a door opening region of the same, are replaced. A new door drive and a new car door/shaft door coupling are arranged at the car, wherein the fastening points of the new coupling are arranged in the region above the door opening and a new shaft door lock is arranged at the original shaft door in correspondence with the arrangement of the new car door/shaft door coupling above the door opening of the shaft door.

### FIELD OF THE INVENTION

The invention relates to a method of modernizing an elevator door system of an elevator installation and to a modernization kit with components required for carrying out the method. It refers to the problem of modernizing elevator door systems of older elevator installations so that they have advantageous operating characteristics attainable with new technologies.

### BACKGROUND OF THE INVENTION

The elevator door system includes a car door which in closed state closes a door opening region of the car and frees this door opening region in opened state, a door drive which can move the car door and a shaft door which in closed state closes a door opening region of a shaft access at a floor and frees this door opening region in opened state. The car door opening and the shaft door opening are coincident when the car is disposed at a stop at a corresponding floor. So that the movement at the car door can be transmitted to the shaft door present at each floor there is usually present at the car door a car door/shaft door coupling which is actuated when the elevator car stops at a floor and connects the car door with the corresponding shaft door. The car door/shaft door coupling for this purpose engages, when stopping at a floor, in a shaft door lock present at the shaft door and couples the car door with the shaft door.

A large number of older elevator door systems are in use worldwide in which on occasion a door drive with a crank transmission in each instance moves at least one car door by way of a drive linkage. In that case a crank arm, which can also be present in the form of a crank disc, is usually so driven by a drive motor via reduction gearing that the crank arm executes a pivot movement of preferably approximately 180° for producing an opening movement or a closing movement of the at least one car door. A crank rod is connected at one end thereof with the end of the crank arm and at the other end with a door drive lever, which is pivotably mounted on a frame of the door drive and coupled at its end with the car door. The components of the described door drive are so designed and arranged that a half revolution of the crank arm produces a complete opening or closing movement of the door, wherein the crank transmission ensures an approximately sinusoidal, jerk-free movement of the door with precisely defined end settings. In door systems with more than one car door, a second car door can be driven by the same crank arm via a second crank rod and a second door drive lever symmetrically relative to the first car door.

So that the movement of the car door can be transmitted to the shaft door present on each floor, a car door/shaft door coupling is, as already illustrated in the introduction, usually present at the car door, which coupling is actuated on stopping of the elevator car at a floor and connects the car door with the corresponding shaft door. The car door/shaft door coupling engages, in the case of a stop at a floor, in a shaft door lock which is present at the shaft door and is spread by an unlocking lever connected with the crank transmission, whereby the shaft door is unlocked and the shaft door is subsequently co-moved in correspondence with a movement of the car door/shaft door coupling.

The doors are now synchronously opened and later closed again. At the end of the door closing process the two entrainer skids at the car door are folded together by the action of the unlocking lever on the car door/shaft door coupling, whereby the play-free connection between the car door and the shaft door is removed. Due to the arrangement and the space requirement of the crank transmission the car door/shaft door coupling is disposed below the door drive and to a substantial extent it is fastened in the region of the car door opening on the car door. Due to this arrangement of the car door/shaft door coupling at the car side, the shaft door lock at the shaft door side is obviously also fastened on the shaft door in the region of the shaft door opening. The door openings of car door and shaft door are defined by a passage height HT and a passage width BT of the car entrance or shaft entrance.

Door drives of the described kind are increasingly susceptible to repair and maintenance due to age. The mechanically relatively complex door drive with drive motor, motor brake, crank transmission with reduction gearing and several lever joints requires, due to the construction thereof, a considerable effort for inspection, maintenance and readjustment. This effort significantly rises with increasing age of the door drive parts, since ever more parts have to be repaired due to wear as a consequence of age. Many of these parts are no longer used in new door systems and therefore have to be reconstructed in costly individual work. The crank transmission with reduction gearing and drive linkage moreover forms a substantial source of noise, is poorly adaptable to changed building utilization and imposes mechanical limits on the design of a door travel plot. These limits and disadvantages are hardly acceptable in current elevator installations.

A method of replacing shaft doors is known from JP 2000-289955, wherein a car door is provided with a second car door/shaft door coupling whereby the car door can be operated for a time period of the shaft door conversion and old as well as new shaft doors can be operated. This method does not offer a solution to the replacement of a car door with maintenance of principal parts of the existing shaft door.

A modular elevator door system is known from EP 1 621 510, wherein car door and shaft door are constructed from basic modules of the same shape. It is disadvantageous that no efficient possibility is indicated how such a system for modernization can be used without shutting down an elevator installation for a longer period of time.

### SUMMARY OF THE INVENTION

The present invention has the object of proposing measures which make it possible with existing elevator installations to eliminate the aforesaid disadvantages with the smallest possible outlay. In particular, an existing door system, especially a car door drive, susceptible to repair shall be able to be modernized in simple manner and a shutdown time of the elevator installation for execution of such modernization shall be kept small.

The object is fulfilled by a method according to the present invention for modernizing an elevator door system of an elevator installation as well as a modernization kit with components required for performance of the method.

In the method according to the present invention an elevator door system, which comprises at least one car door, a door drive, a car door/shaft door coupling arranged in a car door opening region, and at least one shaft door with a shaft door lock arranged in a shaft door opening region, is modernized by the following steps:
demounting the old door drive and the old car door/shaft door coupling;
mounting a new door drive and a new car door/shaft door coupling at the car, wherein the fastening points of the new coupling are arranged in the region above the door opening;
demounting the old shaft door lock; and
mounting a new shaft door lock at the original shaft door in correspondence with the arrangement of the new car door/shaft door coupling above the door opening.

The modernization kit according to the present invention is characterized in that the modernization kit consists of two groups of components, wherein a first group comprises at least one new door drive and at least one new car door/shaft door coupling and a second group comprises new shaft door locks and intermediate or door carrier plates corresponding at least with the number of floors or shaft doors of the elevator installation, wherein the components of the first group are provided as parts for conversion of the car door system and the components of the second group are provided as parts for conversion of the shaft doors.

The present invention is accordingly based on the concept of modernizing an old elevator door system with smallest possible effort, wherein in the first instance existing original shaft doors together with the associated existing shaft door frames and shaft door guides are retained. In addition, the car door can, from case to case, remain. Merely the wear-intensive parts, such as the existing car door drive and the car door/shaft door coupling, are replaced by a new door drive with new car door/shaft door coupling and the old shaft door lock at the shaft door side is replaced by a new shaft door lock matched to the new car door/shaft door coupling.

The advantages achieved by the method according to the present invention and by the use of the modernization kit according to the present invention are substantially to be seen in that a building can be equipped simply, quickly and with low cost with a new low-noise, easily adjustable elevator door system and that existing shaft doors can in that case be left. Merely the shaft door locks, which together with the car door/shaft door coupling form a functional unit, are replaced. This replacement can be made simply with use of adapted intermediate plates and parts. Shaft doors are integrated in a building structure and the door frames thereof are fixedly connected with, for example, walling. Since these parts can be reused, a conversion of the elevator door system is possible in a short time and without significant influence on building occupiers. In addition, noise emissions during the conversion phase are low. This advantage is particularly significant in high buildings. High buildings usually also include numerous stopping points. A correspondingly high outlay of costs and time would be required in replacement of all shaft doors.

Advantageously, in a first method step the door drive and the car door/shaft door coupling are converted and the shaft door lock of a lowermost floor is subsequently converted and adjusted. The car or a roof of the car is in that case preferably used as work platform. After conversion of the lowermost floor has been carried out the car is moved a floor higher and a shaft door lock of this next higher floor is converted and adjusted. This process is repeated for the shaft door locks of each next higher disposed floor until all shaft door locks belonging to the elevator installation are converted and adjusted. This method of procedure allows working upwardly from below, whereby there is no risk of collision of the newly mounted car door/shaft door coupling with old shaft door locks.

In addition, the original car door is, from case to case, replaced by a new car door within the scope of the conversion or even an entire car body with car doors, door drive and car door/shaft door coupling is replaced within the scope of the modernization. This alternative is of interest, since significant elevator components, which are subject to ageing and wear, can thus be replaced in a modernization commission without wall and building renovation being necessary for that purpose.

On many occasions the old door drive is realized by means of a crank drive. The new door drive is now advantageously a ‘linearly moved door drive’. To be understood by that is a door drive of which the components acting on the car door execute a linear (straight) movement. Door drives of that kind are, for example:
a cogged belt or nubbed belt which is guided by two belt pulleys and driven by these and the belt runs—which extend between the belt pulleys—of which form a linearly (straight) moved drive means,
a link chain, which is guided and driven by two sprockets, or a roller chain or a ball chain,
a linear motor or also
a pneumatic or hydraulic cylinder with linearly moved piston rod.

This is advantageous, since with a door drive of that kind it is possible to realize, without substantial outlay, different travel profiles able to be set in correspondence with building-specific demands. In addition, linearly operated door drives are usually quiet and also space-saving.

Preferably, it is provided that the new shaft door lock is connected by means of a wire pull or Bowden pull with an emergency unlocking lock present in the existing shaft door. An emergency unlocking serves the purpose of being able to open a shaft door from the floor from outside. This serves, for example, for releasing trapped passengers in the case of a defect of the elevator installation or also serves for maintenance purposes. This emergency unlocking is usually arranged in the door field region of the shaft door in correspondence with the arrangement of the old shaft door lock. This existing emergency unlocking can be connected in simple manner with the new shaft door lock by means of a wire pull or Bowden pull. This is economic, requires no intervention in the structure of the building and the handling of the emergency unlocking is unchanged for the users.

Advantageously the new shaft door lock is connected with the original shaft door by means of an intermediate plate. This is advantageous, since an intermediate plate of that kind can be made in a factory and provided with required connecting points such as threads, abutments, etc. Conversion in the building is thereby accelerated.

Alternatively, the new shaft door lock is integrated in the original shaft door by means of a door carrier plate in that original door roller supports are demounted and replaced by the new door carrier plate, wherein the new door carrier plate offers connecting points for door guide rollers and the new shaft door lock. This is advantageous, since space can thereby be saved, as a need for space for the original door support is eliminated and an entirely more favorable constructional variant arises. At the same time existing door roller types can be reused.

Preferably counter-members, such as electrical contact or locking hook, belonging to the shaft door lock can be placed with respect to the new shaft door lock by means of an assembly template. The shaft door lock requires a counter-member in which the lock or the locking hook of the lock engages for the purpose of locking. In the same manner, an electrical contact, which monitors correct locking, requires a corresponding contact counter-member. These counter-members are fastened to the existing, old shaft door frame. An assembly template is suitable in optimal manner for placing counter-members of that kind with respect to a reference point which corresponds with the new shaft door lock. Conversion in the building can thereby be undertaken rapidly, securely and economically.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1k is an elevation view of an elevator car with an old door drive and car door/shaft door coupling;

FIG. 1s is an elevation view of a shaft door with an old shaft door lock;

FIG. 2k is an elevation view of the elevator car with a new door drive and car door/shaft door coupling according to the present invention;

FIG. 2s is an elevation view of the shaft door with a new shaft door lock according to the present invention;

FIG. 3 is an enlarged fragmentary detail view of the new shaft door lock shown in FIG. 2s;

FIG. 4 is a perspective view of the new shaft door lock shown in FIG. 3;

FIG. 5 is a perspective view of a shaft door system at a floor; and

FIG. 6 is a schematic view of an elevator installation during modernization according to the present invention.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

Functionally identical parts are provided in all figures with the same reference numerals.

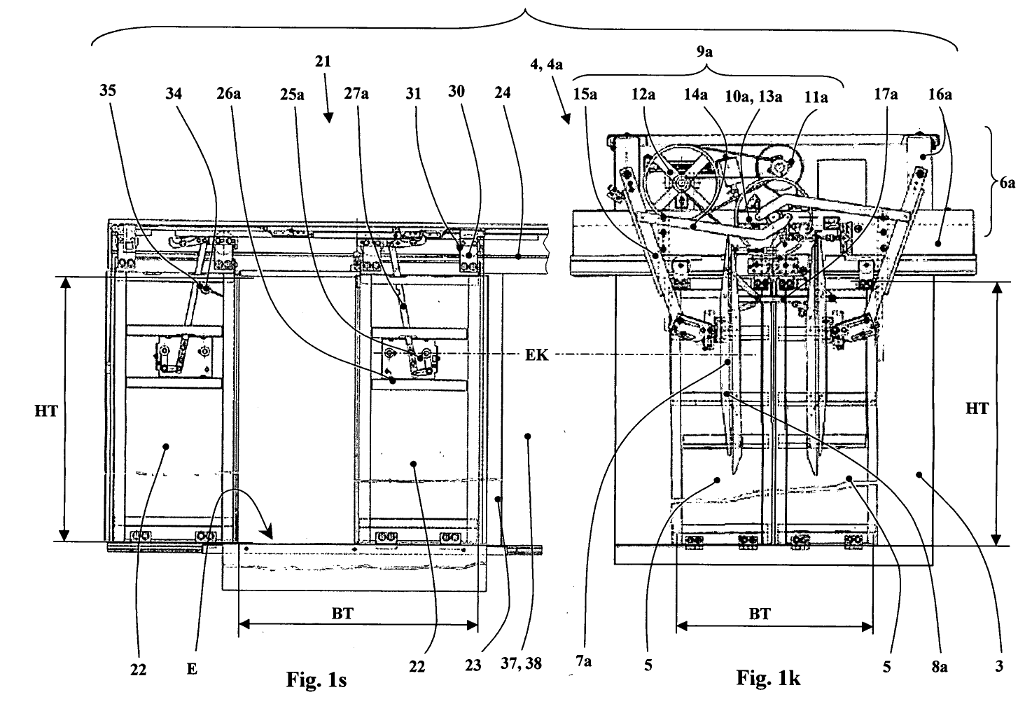

FIG. 1k and FIG. 1s show an elevator door system 2 as is currently used. The illustrations are schematic and not to scale. The elevator door system 2 consists of a car door system 4 and a shaft door system 21. The car door system 4 closes and opens according to need the access to an elevator car 3 and the shaft door system 21 closes and opens according to need the access from a floor E to a shaft 40, in which the car 3 is arranged to be movable. A car door and a shaft door define a door opening. The door opening or a corresponding region of the door opening is defined by a free passage height HT and a free passage width BT of the car entrance or shaft entrance. This door opening region HT×BT accordingly corresponds with the passage which is free for entering the car when car door and shaft door are opened. The car door system 4 and the shaft door system 21 are connectible together in such a manner that a common opening or closing is made possible when the car door system 4 stops in the region of a shaft door system 21. An old car door system 4a, as illustrated in FIG. 1k, consists in the illustrated example of two car doors 5 and a door drive 6a. The old car door system 4 is a component of the elevator car 3. The illustrated door drive 6a moves the two car doors 5 via a drive linkage by means of a crank transmission 9a. A crank arm 13a, which here is present in the form of a crank disc 10a, is so driven by a drive motor 11a via a reduction gearing 12a that the crank arm 13a executes a pivot movement of approximately 180° for generating an opening movement or a closing movement of the car doors 5. A crank rod 14a is connected at one end thereof with the crank arm 13a or crank disc 10a and at the other end thereof with a door drive lever 15a. The door drive lever 15a is in turn pivotably mounted at one end at a frame 16a of the door drive and coupled at its other end with the car door 5. The second door 5 is connected in mirror image in equally acting manner with the crank arm 13a. The components of this door drive 6a are so shaped and arranged that a half revolution of the crank arm 13a produces a complete opening or closing movement of the car door 5, wherein the crank transmission 9a produces an approximately sinusoidal, jerk-free movement of the car door with precisely defined end settings. In car door systems 4 with only one car door 5 or only one door leaf, the components of the second car door are redundant, or in the case of telescopic door systems further, downstream car doors are connected with the upstream car door by means of translation elements.

The old car door system 4a according to FIG. 1k further includes a car door/shaft door coupling 7a, by means of which the movement of the car door 5 is transmitted to a shaft door 22 present at each storey E. FIG. 1s shows a shaft door system 21 adapted to the old car door system 4a illustrated in the foregoing. The shaft door system 21 consists, in adaptation to the old car door system 4a, of a door frame 23, two shaft doors 22, and door guides 24 integrated in the door frame 23. The number of shaft doors 22 is usually oriented to the number of car doors 5. The shaft doors 22 each include an old shaft door lock 25a, which locks the associated shaft door 22 in closed state. FIG. 1s shows for this purpose, on the right-hand side of the figure, a shaft door 22 in closed and locked position and, on the left-hand side, a shaft door 22 in opened position. In the case of a stop at a floor E, the car door/shaft door coupling 7a now engages in the old shaft door lock 25a present at the shaft door 22. The car door/shaft door coupling 7a is spread or pushed apart by an unlocking lever 17a, which is illustrated in FIG. 1k, connected with the crank transmission 9a. The old shaft door lock 25a at the shaft door side is thereby actuated in such a manner that the shaft door 22 is unlocked and subsequently co-moved in correspondence with the movement of the car door/shaft door coupling 7a or the car door 5. The doors of the car side and shaft side are thus opened and later closed again synchronously. At the end of the door closing process the car door/shaft door coupling 7a at the car door 5 is folded together by the action of the unlocking lever 17a, whereby the play-free connection between the car door 5 and the shaft door 22 is cancelled and the shaft door 22 is locked.

In addition, a conventional emergency unlocking device 34 is illustrated in FIG. 1s. For this purpose an emergency unlocking lever 35 engages in a linkage 27a of the shaft door lock 25a. By means of the emergency unlocking device 34, which in the example is disposed on the shaft door 22 or on a leaf of the shaft door 22, the old shaft door lock 25a can now be actuated from the floor E₁ . . . E_{N} and thus the shaft door 22 unlocked. This can be required for, for example, servicing and maintenance operations.

Due to the arrangement and the space requirement of the crank transmission 9a the car door/shaft door coupling 7a is disposed below the door drive 6a and, as apparent in FIG. 1k, it is for a substantial part fastened in the region of the car door opening HT×BT on the car door side by way of fastening means 8a. By virtue of this arrangement of the car door/shaft door coupling 7a at the car side also the old shaft door lock 25a at the shaft door side, or at least the coupling parts thereof, is or are obviously fastened in the region of the shaft door opening HT×BT to the shaft door 22 by way of fastening means 26a. The dimensions of the door width BT and the door height HT for the car door (FIG. 1k) and for the shaft door (FIG. 1s) are usually identical. Exceptionally, different shaft door widths or shaft door heights at different floors E are obviously also possible when, for example, merely reduced shaft door dimensions are available at specific floors.

It is obvious that door drives 6a of that kind are very maintenance-intensive and susceptible to noise. In addition, a travel plot of the doors can be influenced only by the design of the crank geometry. It is accordingly obvious that door systems of that kind are increasingly to be converted to new electronically controllable drives.

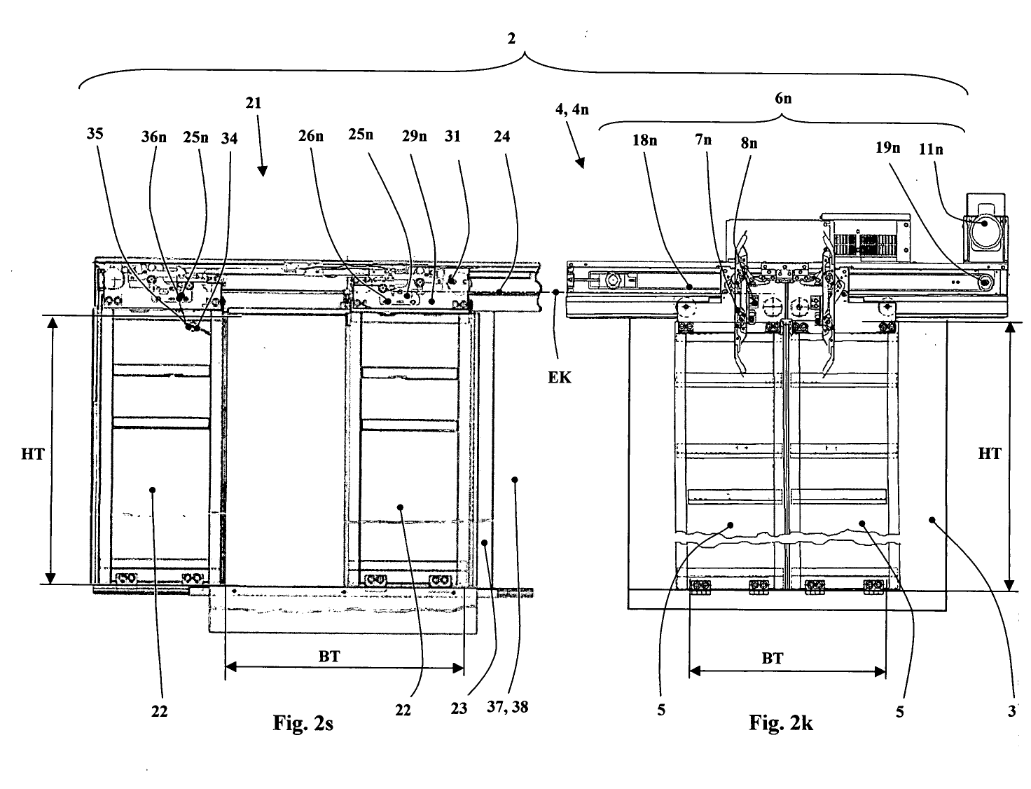

A converted or modernized elevator door system 2 according to the present invention is now illustrated in FIGS. 2s and 2k. As apparent in FIG. 2s, the old shaft door 22 is essentially left. Merely the old shaft door lock 25a together with the associated linkage 20a is removed and replaced by a new shaft door lock 25n. The new shaft door lock 25n is arranged in the upper region of the shaft door 22 and fastenings 26n of the new lock 25n are disposed above the door opening region HT×BT. The existing emergency unlocking device 34 is connected with at least one of the new shaft door locks 25n by means of wire or Bowden pull 36n. It is obvious that a conversion of that kind of the shaft door system 21 can be carried out very quickly and without significant influencing of the building, since, in particular, the door frame 23, which to a substantial extent is connected with the building structures 37, does not have to be changed.

FIG. 2k shows the modernized car door system 4n. The old door drive 6a together with the crank arms 13a and levers 15a and the old car door/shaft door coupling 7a is completely removed. Instead thereof, a new door drive 6n with a so-called linearly operated door drive is installed. Moreover, the converted door contains a new car door/shaft door coupling 7n which, in the illustrated example, is connected with a door carriage and the existing car door 5 by way of fastening means 8n. The car door/shaft door coupling 7n is disposed substantially above the door opening region HT×BT and it is accordingly again arranged at a coupling height EK corresponding with the shaft door lock. The arrangement of the car door/shaft door coupling 7n in this connection corresponds with a placing such as is used with currently known new door drive systems. It is apparent in this respect that the intention exists and realized to install in an existing elevator system 2 a new door 6n which is accompanied by the full functionality of new, regulated door drives. In the example, the drive unit consists of a regulated door motor 11n, which by way of drive pulleys 19n drives a linearly moved belt or traction means 18n at which the door 5 and the corresponding new car door/shaft door coupling 7n are suspended. In the example, as many of the existing door parts as possible were left and reused. This can be adapted according to need. Thus, in many cases entire car doors, car fronts or even entire cars 3 are replaced by new components. This is often useful inasmuch as the car 3 or the door system 4 thereof experiences substantially more movement cycles than, by comparison, a shaft door system 21, since an elevator car 1 usually contains only one car door system 4, but a plurality of shaft door systems 21.

The indicated possibility of being able to leave the shaft door system itself, together with the parts—such as, for example, the door frame 23 and the shaft door drives 24 connected therewith—connected with the walling, in the original state and nevertheless to be able to use a modern door drive system is important.

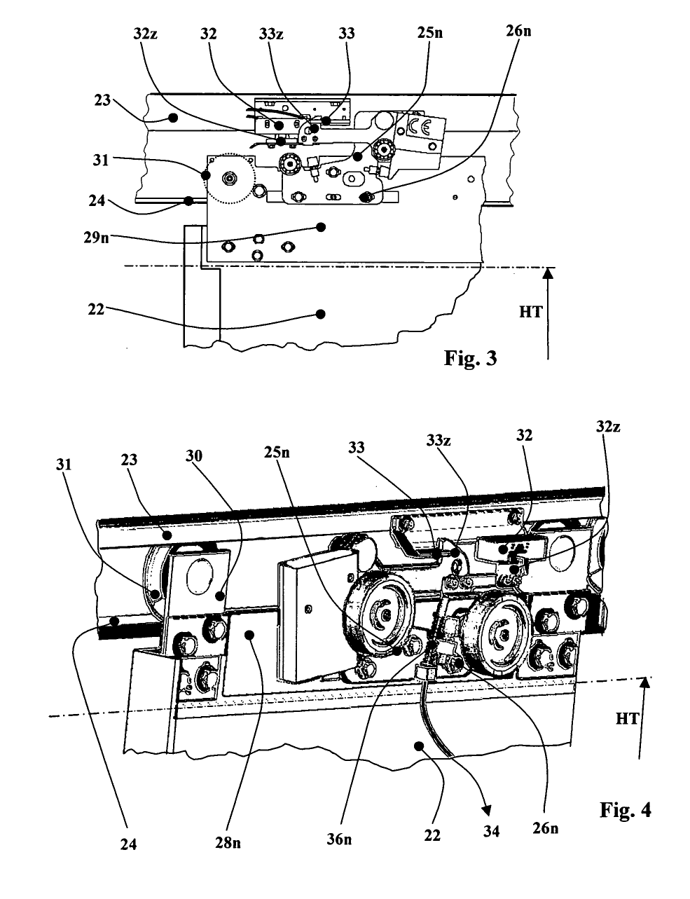

A converted new shaft door lock 25n according to the present invention is illustrated in FIG. 3. The new shaft door lock 25n is fastened by means of a door plate 29n to the existing shaft door 22 and old door rollers 31 are fastened to this new door plate 29n. Fastening points 26n for fastening the new shaft door lock 25n are disposed above the door opening region HT×BT. Old door rollers 31 signify door rollers which correspond with the geometry and use data of the old rollers 31 and which thus match the existing guide system 24. Obviously, on occasion, as-new unused rollers 31 are often used at the same time. With respect to the new shaft door lock 25n, the associated counter-members such as an electrical contact 32 and a locking plate 33 are mounted on the existing door frame 23. An assembly template (not shown) is advantageously used for this purpose. Depending on the geometry of the door frame 23, intermediate members are required for fastening the contact 32 and the locking plate 33. Intermediate members of that kind can be provided in dependence on the type of the existing door drive system.

FIG. 4 shows a newly installed shaft door lock 25n in a perspective view. By contrast to the embodiment according to FIG. 3 in this example an intermediate plate 28n is used for fastening the new shaft door lock 25n. The intermediate plate 28n is connected with existing door roller retainers 30. A corresponding conversion set is more favorable, since simpler parts can be provided. The new locking plate 33 together with contact 32 is connected as a unit with the old door frame 23. The new shaft door lock 25n engages by its locking hook 33z in the locked state in the locking plate 33 and thus prevents opening of the door 22 as long as the hook 33z is engaged with the locking plate 33. A contact bridge 32z mounted on the locking hook 33z closes the contact 32 when the hook 33z is engaged with the plate 33. An effective locking of the shaft door 22 is thus controlled.

It is further apparent in FIG. 4 how the wire/Bowden pull 36n is engaged with the locking hook 33z or the shaft door lock 25n. The wire/Bowden pull 36n is, as apparent in FIG. 2s, connected with the emergency locking device 34 and enables unlocking of the shaft door 22 as required.

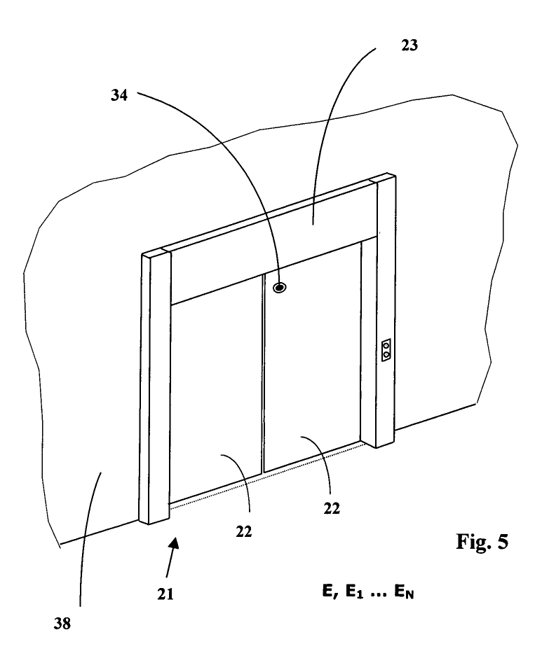

A shaft door 22 is illustrated in FIG. 5 from the viewing point of a floor E. The shaft door frame 23 is fixedly connected with the building or the masonry 38 of the building. Shaft doors 22 are installed in the door frame 23 to be able to be pushed laterally. The emergency unlocking device 34 is mounted on the shaft door 22. The advantage of the present invention is particularly evident in this FIG. 5, the external appearance of the shaft door system 21 being entirely unaffected by the conversion. No work on walls is required and the individual floor regions E₁ to E_{N} are not exposed to conversion mess. The building remains inhabitable and the use of the elevator installation 1 is restricted only for a short time.

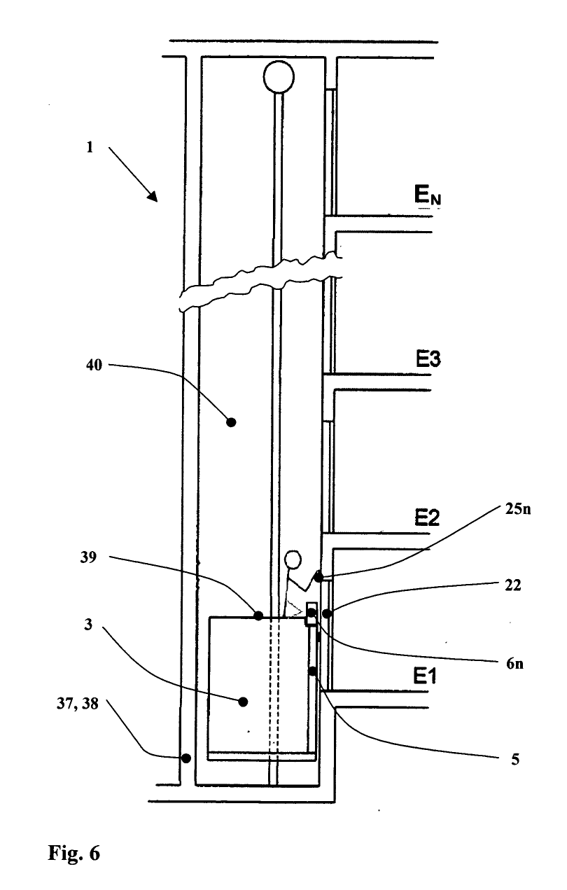

The conversion preferably begins, as illustrated in FIG. 6, with the conversion at the car side in a lowermost floor E₁. The old door components as well as possible car parts are replaced by the new door drive 6n with car door/shaft door coupling 7n and corresponding further new car parts. An engineer, with use of a roof 39 of the car 3 as work platform, can subsequently remove the old shaft door lock 25 in each floor E₁ to E_{N} beginning at the lowermost stop E₁, install the new shaft door lock 25 and if needed carry out equal adjustment by an adjusting template. The engineer can replace all shaft door locks up to the uppermost stop E_{N} in a short time.

A special situation frequently arises with operations at the lowermost stopping point E₁. In the case of low depths of a shaft pit it can be necessary to mount the shaft door lock 25n there without use of the car 3. However, the engineer can clarify these methods on site and define the ideal procedure.

The present description gives the ideal scope of such a modernization. Modifications in the sense of the present invention are obviously possible. Thus, for example, a multi-leaf car door can co-operate with a single-leaf shaft door or a conversion set can contain further adaptation parts (for example display units, door monitoring units, cable guides or cable channels, etc.) for simple installation of new parts with respect to existing components.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method of modernizing an elevator door system of an elevator installation, wherein the original elevator door system comprises:
at least one original car door arranged at a car,
an original door drive which drives the original car door,
an original car door/shaft door coupling which is mounted at the original car door, wherein fastening points of the coupling are arranged in a door opening region when the original car door is closed,
at least one shaft door arranged at a floor of the elevator installation, and
an original shaft door lock, which is mounted at the shaft door and which locks the shaft door when no engagement of the original car door/shaft door coupling is present and enables opening of the shaft door when the coupling is in engagement with the original shaft door lock, wherein the fastening points of the original shaft door lock are arranged in the region of the door opening when the shaft door is closed,
comprising the following method steps:
a. demounting the original door drive and the original car door/shaft door coupling;
b. mounting a new door drive and a new car door/shaft door coupling at the car, wherein fastening points of the new coupling are arranged in a region above the door opening;
c. demounting the original shaft door lock; and
d. mounting a new shaft door lock at the shaft door in correspondence with the arrangement of the new car door/shaft door coupling.

2. The method according to claim 1 wherein first the original door drive and the original car door/shaft door coupling are converted by performing said steps a. and b., and subsequently the original shaft door lock of a lowermost floor is converted by performing said steps c. and d. and adjusted, subsequently an original shaft door lock of a next higher floor is converted by performing said steps c. and d. and adjusted and this process is repeated for original shaft door locks of each next higher disposed floor until all the original shaft door locks belonging to the elevator installation are converted and adjusted.

3. The method according to claim 1 wherein the at least one original car door is replaced within the scope of the modernization by a new car door or that an entire car body with car doors, a door drive and a car door/shaft door coupling is replaced within the scope of the modernization.

4. The method according to claim 1 wherein the original door drive is a crank drive and the new door drive is a linearly moved drive means, wherein a flexible traction means guided and driven by drive means pulleys is used.

5. The method according to claim 1 wherein the new shaft door lock is connected by a wire or a Bowden pull with an emergency unlocking lock present in the shaft door.

6. The method according to claim 1 wherein the new shaft door lock is connected with the shaft door by an intermediate plate.

7. The method according to claim 1 wherein the new shaft door lock is integrated in the shaft door by a door carrier plate in that an original door roller support is demounted and replaced by a new door carrier plate, wherein the new door carrier plate offers connecting points for door guide rollers and the new shaft door lock.

8. The method according to claim 1 wherein counter-members belonging to the original shaft door lock are positioned with respect to the new shaft door lock by means of an assembly template.

9. The method according to claim 8 wherein the counter-members include at least one of an electrical contact and a locking plate.

10. A modernization kit for modernizing an elevator door system of an elevator installation, wherein the modernization kit includes of two groups of components, a first group comprising
a door drive, and
at least one car door/shaft door coupling,
and a second group comprising
shaft door locks and intermediate plates or door carrier plates at least corresponding with a number of floors of the elevator installation,
wherein the components of the first group are parts for conversion of the car door system and the components of the second group are parts for conversion of the shaft door system.
